(19) United States
(12) Patent Application Publication
(10) Pub. No.: US 2017/0300923 A1
(43) Pub. Date: Oct. 19, 2017

(54) SYSTEM FOR IDENTIFYING ROOT CAUSES OF CHURN FOR CHURN PREDICTION REFINEMENT

(71) Applicant: Conduent Business Services, LLC, Dallas, TX (US)

(72) Inventors: Akhil ARORA, New Delhi (IN); Manoj GUPTA, Karnataka (IN); Sainyam GALHOTRA, Chandigarth (IN); Neeta PANDE, Karnataka (IN); Shourya ROY, Bangalore (IN)

(21) Appl. No.: 15/132,767

(22) Filed: Apr. 19, 2016

(51) Int. Cl. G06Q 30/00; G06Q 30/02

(52) U.S. Cl. CPC G06Q 30/01; G06Q 30/0201; G06Q 30/0204

(57) ABSTRACT

A system for identifying a root-cause of customer churn for churn prediction refinement. Customer transactions are analyzed to identify discriminating patterns that appear frequently in the transactions of customers who have churned and infrequent in the transactions of customers who have not churned. Attributes associated with the discriminating patters are the root-causes of customer churn. The attributes of customer transactions associated with the root-causes of customer churn are weighted. Churn prediction is performed on the updated customer transactions to obtain a second list of customers likely to churn. The first and second lists are compared to determine whether convergence has occurred. Upon convergence, the second list of customers likely to churn to a display device of a customer care agent so that those customers on the second list can be prioritized ahead of customers who are not likely to churn. Otherwise, the process repeats until convergence.

### TECHNICAL FIELD

The present invention is related, in general, to customer relationship management systems and, more particularly, to computer implemented systems and methods for identifying a root-cause of customer churn for churn prediction refinement.

### BACKGROUND

Customer relationship management (CRM) are widely implemented for managing a company's interactions with customers, clients, and sales prospects. The goal is to attract and new clients, nurture and retain existing clients, entice former clients to return, and reduce the costs of marketing and client service. A churned customer is one who no longer avails themselves of the products or services of a given company or organization. Factors that can lead to customer churn include, for instance, lack of customer support, poor interaction with customers, and the like. Methods for predicting customers likely to churn is of interest to customer-service organizations. Further, methods which can identify one or more root-causes of customer churn are needed to enhance or refine churn prediction.

### BRIEF SUMMARY

What is disclosed is a computer implemented method for use with a customer relationship management system utilizing an application server with at least one processor executing machine executable program code for churn prediction refinement. In one embodiment, the application server queries a database containing a plurality of customer transactions to retrieve transactions of customers who have churned and transactions of customers who have not churned, each transaction being associated with a set of attributes and a level of support. Each customer transaction is associated with a set of attributes and a level of support defined as a cost. A processor executes machine readable program instructions to perform frequent pattern mining on the customer transactions to identify a discriminating pattern of attributes which appears frequently in the transactions of customers who have churned but infrequently in the transactions of customers who have not churned. Attributes associated with the discriminating pattern are determined to be a root-cause of customer churn. The processor executes machine readable program instructions to perform churn prediction on the customer transactions to obtain a first list of customers who are likely to churn. In a manner more fully disclosed herein, attributes of customer transaction in the discriminating pattern are weighted. Churn prediction is performed on the customer transactions to obtain a second list of customers who are likely to churn. The first and second lists of customers likely to churn are compared to determine whether they are substantially the same, i.e., convergence has occurred. Upon convergence, the first or second list of customers who are likely to churn is communicated to a display device of a customer care agent. Otherwise, the process repeats until convergence.

Features and advantages of the above-described system will become readily apparent from the following detailed description and accompanying drawings.

### BRIEF DESCRIPTION OF THE DRAWINGS

The foregoing and other features and advantages of the subject matter disclosed herein will be made apparent from the following detailed description taken in conjunction with the accompanying drawings, in which:

FIG. 1 shows an example customer relationship management system wherein various embodiments hereof can be implemented;

FIG. 2 is a flow diagram which illustrates one example embodiment of the present method for identifying a root-cause of customer churn for churn prediction refinement;

FIG. 3 is a continuation of the flow diagram of FIG. 2 with flow processing continuing with respect to node A; and

FIG. 4 illustrates a workstation whereon various aspects of the methods shown and discussed with respect to the embodiments of FIGS. 1, 2-3 are performed using the plurality of records stored in a database of customer transactions.

### DETAILED DESCRIPTION

What is disclosed is a system for identifying a root-cause of customer churn for churn prediction refinement.

### Non-Limiting Definitions

An “organization” or “company” refers to a person or entity which engages in commerce, i.e., in the business of providing goods and/or services to the general public.

A “customer” is someone who avails themselves of the goods and services of an organization.

A “customer-care agent” or simply “agent” refers to any individual, a machine, or a software program which responds to a query/issue/problem raised by a customer. The customer-care agent is responsible for providing solutions or services to the customer.

A “message” refers to any audio, video, or written communication involving an interaction between a customer and at least one customer-care agent. The message may take the form of an instant message, an electronic mail, a voice mail, a text message, or a letter. The message can be initiated by either the customer or customer-care agent.

A “customer transaction”, or simply “transaction”, refers to a software data structure which contains information extracted from an interaction between a customer and a customer-care agent. Each customer transaction is associated with a set of attributes and a level of support.

A “plurality of attributes” are associated with each customer transaction. Attributes include transmitted messages, worklogs, verbal/written comments, a video recording from a surveillance camera, customer interviews, customer feedback, results of customer surveys, follow-up phone conversations between customers and agents, and response times to customer queries. Other attributes include a timestamp associated with each of messages, priorities associated with each customer message or customer, an overall sentiment of the customer interaction, a topic of discussion, a location of the customer, and a social media influence of the customer. Other attributes include customer-specific information such as: gender, geography, age, a type of goods/service, and the like. Each organization would define the attributes for their customer transactions given the type of business they have with those customers. For example, a telecom company may have attributes taking the form of: annual billing amount, voice/data usage, customer plan, payment history, customer interactions, complaints and issues, service interruptions, and the like. A financial organization may have attributes may taking the form of a number of years of association with the bank or organization, account type, credit limit, credit history, complaints, issues, and the like. Since the attributes would necessarily be organization-specific and will likely vary from one organization to another, a discussion as to a set of attributes for a particular organization or organization-type is omitted. Attributes may be combined, aggregated, scored, prioritized, modified, or deleted as needed.

A “level of support” is associated with each customer transaction and are in increasing order of cost to the organization, where Sₖⁱ, is the k^{th} level of support the organization provides for the i^{th} transaction, k=1 to K where K is a number of levels of support. Each level of support has an associated training program or training module which is targeted for employees involved with specific types of transactions. Organizational cost for a given level of support provided can be measured in terms of hours spent dealing with a particular customer over their transaction and the employee training needed for customer service personnel to handle or otherwise manage a particular customer issue for a given type of transaction. For example, assume there are K=10 different levels of support, each successive support level having a higher level of cost to the organization than a previous level of support. A first level of support (k=1) may be the cost to the organization for handling a simple inquiry by a customer relating to a product or service they have purchased. For this particular type of transaction, training would be minimal for a customer support person to learn how to handle this type of transaction and the time spent handling the customer's inquiry quickly is minimal to the organization. A second level of support (k=2) may be the cost associated with handling multiple questions from a customer about the product and/or service they have received for a given transaction. For this type of transaction, handling that customer's issues is more involved than responding to a simple inquiry. As such, the cost to the organization in terms of customer support training needed to deal with this type transaction and time spent managing this issue is higher than the cost associated with the first level. A third level of support (k=3) may be dealing with a customer's issue regarding a broken part, a replacement part, or perhaps a follow-up service. The overall cost to the organization for managing this type of transaction is higher than the previous level as it is more involved and perhaps requires interaction with other departments within the organization to get the customer's issues resolved. Training for dealing with this type transaction would be more involved as well. Levels of support k=4, 5, . . . , 10 would be increasingly more costly to the organization as the customer's issues for a given transaction-type become more difficult to resolve to the customer's satisfaction. The highest support level (k=10) may be, for example, the president of the company having to get involved to resolve that customer's issues. At this point, it should be clear that each customer transaction is associated with a plurality of attributes and each transaction has an organizational cost associated with that transaction type. Since the levels of support provided would necessarily be organization-specific and would most likely vary from one organization to another, a discussion as the levels of support for a particular organization or a particular type of organization is omitted. Each organization would define the levels of support for the various types of transactions they conduct with their customers and would discretize those support levels by increasing cost.

“Churn” in a business context means “customer turnover”. For example, if a customer is dissatisfied with the level of customer support provided by a customer care agent or a customer is not prioritize correctly given their issues or concerns, then that customer will no longer avail themselves of the goods or servers being offered by the company/organization and will go elsewhere. Churn prediction helps customer care centers identify customers who are likely to churn.

“Churn prediction” is a computer-implemented algorithm which analyzes transactions of customers who have already churned and transactions of customers who have not churned and generates a list of customers who are likely to churn. In one embodiment, churn prediction generates a hypergraph comprising a plurality of nodes and a plurality of edges. Each of the nodes in the hypergraph represents a customer. The edges inherently correspond to the attributes associated with that customer. A similarity matrix is determined which is representative of the similarity between each of a plurality of the customers represented by the plurality of nodes. The similarity matrix is then decomposed into a first and second matrix. A third matrix is created based on the first and second matrices and a scaling parameter. A fourth matrix is created based on the attributes of customers who have already churned. Based on the third and fourth matrices, a list of customers who are likely to churn can be determined. The algorithm preferably resides on an application server with a plurality of processors configured to manipulate the hypergraph accordingly to generate the list of customers likely to churn. Churn prediction algorithms are available in various streams of commerce.

“Frequent pattern mining” finds one or more patterns across a set of records in a database of records, a pattern effectively discriminating one set of records from all the other records. More formally, given a database D containing transactions T₁ . . . T_{N}, find all patterns P that are present in at least a fraction s of those transactions. The fraction s is referred to as the minimum support and can be expressed as an absolute number, as a fraction of the number of transactions in the database which have the same pattern, or in terms of a percentage. Each transaction can be considered a sparse binary vector or as a set of discrete values representing the identifiers of the binary attributes that are instantiated to the value of 1. Each attribute corresponds to an item and the binary value represents whether or not that attribute is present in the transaction. Each attributed will have an associated value of support, i.e., how many times that particular attribute appeared. Data mining and analysis are emerging fields which include automated methods to analyze patterns and models for various forms of data with applications in business analytics. The reader is directed to the text: Frequent Pattern Mining, Charu C. Aggarwal (Ed), Jiawei Han (Ed), Springer (2014), ISBN-13: 978-3319078205. Frequent pattern mining algorithms are available in various streams of commerce.

A “discriminating pattern”, generated by performing frequent pattern mining, refers to a set of attributes which appears frequently in the transactions of customers who have churned but which appears relatively infrequently in the transactions of customers who have not churned. The degree of frequency and measure of relative infrequency are pre-defined by a user performing frequent pattern mining. Attributes of the identified discriminating pattern are the root-causes of customer churn.

A “weight” is assigned to attributes. (Step 1) All the attributes that are not in the identified discriminating pattern are assigned a weight of 1, (i.e., they are all given the same significance). (Step 2) From the set of attributes assigned a weight of 1, identify the attribute with a maximum support value (frequency ratio), i.e., an attribute that occurs 10 times in 100 customer transactions possesses a support value of 0.1. Let us call this “baseline support”. (Step 3) Calculate the support of the attributes in the discriminating pattern. The weighting value is calculated as follows: (Support of this attribute−Baseline Support)/Baseline Support. This will be a number greater than 1, and gives relatively higher significance to attributes with more frequency when compared to those with less frequency. The baseline support (Step 2) is identified from the attributes that are not identified as root-causes and have a weight of 1. (Step 4) Multiply this weighting value (Step 3) by the level of support associated with this customer transaction. Note that, now we are multiplying numbers that are both whole number in nature and are greater than 1.

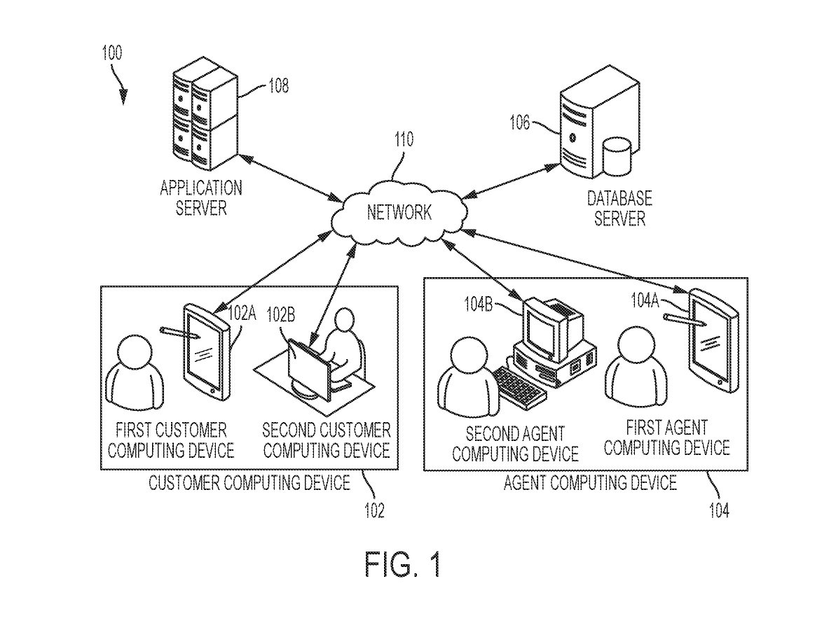

A “Customer Relationship Management (CRM) system” is used by customer-care agents for maintaining and managing interactions of customer-care agents with customers. The CRM system may have defined workflows for customer-care agents to manage various aspects of customer relations. The workflows may include workflows related to organize, automate and synchronize customer service and technical support. FIG. 1 shows an example customer relationship management system 100 wherein various embodiments hereof can be implemented. The CRM system of FIG. 1 includes a customer computing device 102 such as a customer computing devices 102A and 1028, an agent's computing device 104 such as an agent computing devices 104A and 104B, a database server 106, an application server 108, and a network 110 which operatively connects the various devices in the system using a wired or wireless protocol. It should be appreciated that FIG. 1 is illustrative and that other embodiments may comprise multiple customer computing devices, multiple agent computing devices, multiple database servers, and multiple application servers. As such, the embodiment of FIG. 1 is not to be viewed as limiting the scope of the appended claims strictly to that system configuration.

A “computing device”, as shown in FIG. 1 at 102 and 104, includes processors and other electronic components or devices that performs operations in response to executing machine readable program instructions or program codes. The computing device would be used to transmit/received messages corresponding to a problem/query/issue/answer. A computing device may be remotely coupled to any of a plurality of devices over a network. A computing device may comprise a display screen that may be configured to display a user interface to the user. Examples computing devices include a workstation, desktop or laptop, a personal digital assistant (PDA), or a handheld mobile device such as a smartphone, tablet-PC, iPad®, and the like.

A “database server”, as shown in FIG. 1 at 106, is a computing device and/or a record storage/retrieval system configured to store records containing customer transactions T₁, T₂, . . . , T_{N}, where N is the total number of transactions. The database server may obtain the customer transactions from various sources such as file systems, work logs, an application server, or cloud-based systems. A database server can be realized utilizing present technologies such as SQL, Oracle, My SQL, to name a few. A person with ordinary skill would understand that some or all of the functionalities of a database server may be integrated into the agent computing device and or the application server.

An “application server”, as shown in FIG. 1 at 108, is a computing device or a software framework that is dedicated to the efficient execution of procedures, such as programs, routines, or scripts stored in memories for supporting its applied applications. The application server may be configured to send a query to the database server to retrieve some or all of the customer transactions residing therein. The application server may mine social networking websites such as FACEBOOK™, LINKEDIN™ TWITTER™, etc., for interactions between customers and agents, and analyze those interactions to obtain attributes on a per-transaction basis. The application server may be configured to transmit or receive instructions/metadata/transactions between various customer and agent computing devices and may further store a set of rules that may be utilized to assign a priority to a given customer message. In one embodiment, the application server monitors messages between customers and customer-care agents, analyzes those messages, aggregates agent notes, worklogs, comments, determines response times, and the like, and generates the attributes which, in turn, are associated with a respective customer transaction and stored in the database server. The application server may retrieve the agent worklogs, etc. from a central storage system of the company or organization to obtain a given transaction's respective attributes. The application server may present/display a user interface, on the display screen of the agent computing device, display customer transactions, attributes, messages, and the like to the agents. An application server may be realized through various web-based technologies such as a Java web-framework, .NET framework, PHP framework, or any other web-application framework.

A “network”, as shown in FIG. 1 at 110, corresponds to a medium through which conversations and messages flow between various devices of the CRM system. Example network include a Wireless Fidelity (Wi-Fi) network, a Wireless Area Network (WAN), a Local Area Network (LAN), or a Metropolitan Area Network (MAN). Various devices in the system environment can connect to the network in accordance with various wired and wireless communication protocols such as Transmission Control Protocol and Internet Protocol (TCP/IP), User Datagram Protocol (UDP), and 2G, 3G, or 4G communication protocols.

It should be appreciated that the steps of “receiving”, “providing”, “identifying”, “weighting”, “processing”, “calculating”, “comparing”, “performing” and the like, as used herein, include the application of various mathematical operations applied to data according to any specific context or for any specific purpose. It should be appreciated that such steps may be facilitated or otherwise effectuated by a microprocessor executing machine readable program instructions retrieved from a memory or storage device. The various nomenclature used herein such as ‘database of customer transactions’, ‘levels of support’, “churners”, and the rest, are for explanatory purposes and are not to be viewed as limiting the scope of the appended claims solely to embodiments which use these same terms.

### Flow Diagram of One Embodiment

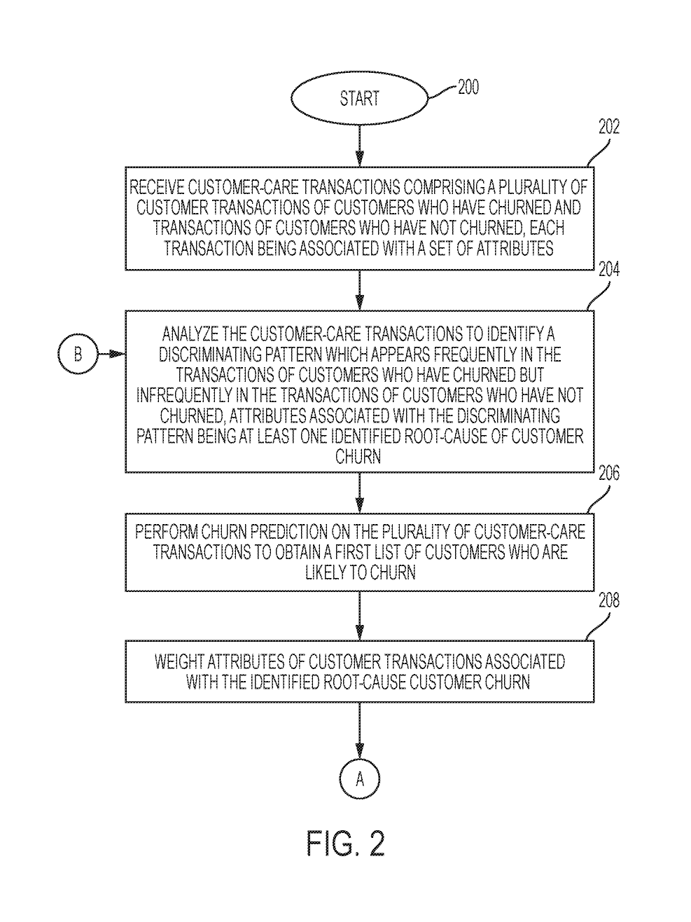

Reference is now being made to the flow diagram of FIG. 2 which illustrates one example embodiment of the present method for identifying a root-cause of customer churn for churn prediction refinement. Flow processing begins at step 200 and immediately proceeds to step 202.

At step 202, receive customer transactions comprising a plurality of customer transactions of customers who have churned and transactions of customers who have not churned, each transaction being associated with a set of attributes.

At step 204, analyze the customer transactions to identify a discriminating pattern which appears frequently in the transactions of customers who have churned but infrequently in the transactions of customers who have not churned, attributes associated with the discriminating pattern being at least one identified root-cause of customer churn.

At step 206, perform churn prediction on the plurality of customer transactions to obtain a first list of customers who are likely to churn.

At step 208, weight attributes of customer transactions associated with the identified root-cause of customer churn.

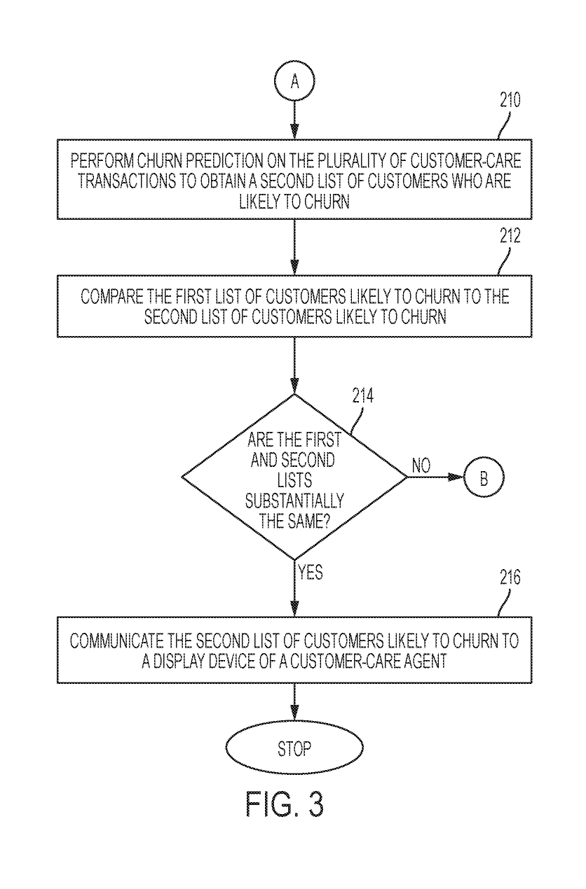

Reference is now being made to FIG. 3 which is a continuation of the flow diagram of FIG. 2 with flow processing continuing with respect to node A.

At step 210, perform churn prediction on the plurality of customer transactions to obtain a second list of customers who are likely to churn.

At step 212, compare the first list of customers likely to churn to the second list of customers likely to churn.

At step 214, a determination is made whether the first and second lists are substantially the same. If so then, at step 216, communicate the second list of customers likely to churn to a display device of a customer-care agent. In this embodiment, further processing stops. Otherwise, if convergence has not occurred, processing repeats with respect to node B until convergence.

It should be understood that the flow diagrams depicted herein are illustrative. One or more of the operations illustrated in the flow diagrams may be performed in a differing order. Other operations may be added, modified, enhanced, or consolidated. Variations thereof are intended to fall within the scope of the appended claims. All or portions of the flow diagrams may be implemented partially or fully in hardware in conjunction with machine readable/executable program instructions.

### Example Networked Workstation

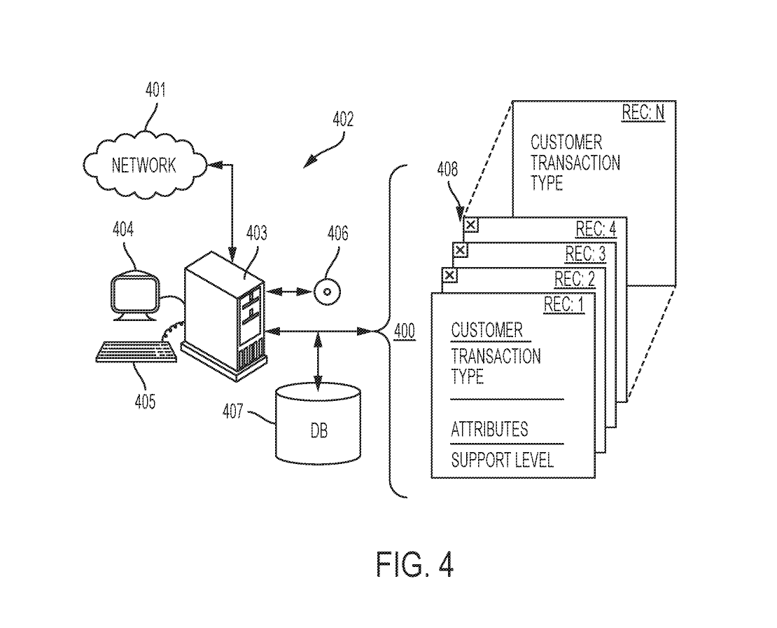

Reference is now being made to FIG. 4 which illustrates a workstation 402 whereon various aspects of the methods shown and discussed with respect to the embodiments of FIG. 1 and FIGS. 2-3 are performed using the plurality of care records of customer transactions, collectively at 400, stored in a database of customer transactions 407.

The computer case 403 of the workstation houses various components such as a motherboard with a processor and memory, a network card, a video card, a hard drive capable of reading/writing to machine readable media 406 such as a floppy disk, optical disk, CD-ROM, DVD, magnetic tape, and the like, and other software and hardware needed to perform the functionality of a computer workstation. The workstation includes a display device 404, such as a CRT, LCD, or touchscreen display. A user can view any displayed records or information and make a selection from menu options displayed thereon. Keyboard 405 and mouse (not shown) effectuate a user input or selection. It should be appreciated that the workstation has an operating system and other specialized software configured to display alphanumeric values, menus, scroll bars, dials, slideable bars, pull-down options, selectable buttons, and the like, for entering, selecting, modifying, and accepting information needed for performing the methods disclosed herein.

The workstation implements a database in storage device 407 wherein records are stored, manipulated, and retrieved in response to a query. The records of customer transactions can be stored in a memory or on a hard drive internal to computer case 403. There are N-records. It should be appreciated that the number of stored records and their order in the database is illustrative. The records of customer transactions, in various embodiments, take the form of Customer Name/ID, a Transaction Type, Attributes, and an associated Support Level for this type of transaction. Records of customers who have churned are shown flagged (at 408) so that these records can be quickly differentiated from records of customers who have not churned in a search of all customer records contained in the database 407. It should be appreciated that the records may contain additional fields, formats, structures, pointers, comments, references, and the like. The records are fully editable by a customer specialist in the organization and may be edited or otherwise modified as needed. Although the database is shown as an external device, the database may be internal to the workstation mounted, for example, on a hard disk therein.

A user or technician may use the user interface of the workstation to identify some or all of the records of transactions in the database for processing, set parameters, set threshold levels, interface with the frequent pattern mining algorithm and/or the churn prediction algorithm. Selections made and various user inputs may be stored/retrieved to a memory (not shown) and to storage devices 406. Default settings and initial parameters can be retrieved from any of the storage devices shown, as desired. Further, a user may dynamically adjust the various parameters being utilized for processing.

Although shown as a desktop computer, it should be appreciated that the workstation can be a laptop, mainframe, or a special purpose computer such as an ASIC, circuit, or the like. The embodiment of the workstation of FIG. 4 is illustrative and may include other functionality known in the arts. Any of the components of the workstation may be placed in communication with other workstations or any devices in communication therewith either by wired or wireless communication via network 401. The embodiment shown is illustrative and should not be viewed as limiting the scope of the appended claims strictly to that configuration. Various modules may designate one or more components which may, in turn, comprise software and/or hardware designed to perform the intended function.

The teachings hereof can be implemented in hardware or software using any known or later developed systems, structures, devices, and/or software by those skilled in the applicable art without undue experimentation from the functional description provided herein with a general knowledge of the relevant arts. One or more aspects of the methods described herein are intended to be incorporated in an article of manufacture which may be shipped, sold, leased, or otherwise provided separately either alone or as part of a product suite or a service.

It will be appreciated that the above-disclosed and other features and functions, or alternatives thereof, may be desirably combined into other different systems or applications. Presently unforeseen or unanticipated alternatives, modifications, variations, or improvements may become apparent and/or subsequently made by those skilled in this art which are also intended to be encompassed by the following claims. The teachings of any textbooks, papers, or other publications referenced herein are each hereby incorporated herein in their entirety by reference.

What is claimed is:

1. A computer implemented method for use with a customer relationship management system utilizing an application server with at least one processor executing machine executable program code for identifying a root cause of customer churn, the computer implemented method comprising:
querying a database containing a plurality of customer transactions to retrieve transactions of customers who have churned and transactions of customers who have not churned, each transaction being associated with a set of attributes and a level of support;
performing, by at least one processor of an application server, frequent pattern mining on the customer transactions to identify a discriminating pattern which appears frequently in the transactions of customers who have churned but infrequently in the transactions of customers who have not churned, attributes in the discriminating pattern being a root-cause of customer churn; and
communicating, by at least one processor, the root-cause of customer churn to a display device of a customer care agent.

2. A computer implemented method for use with a customer relationship management system utilizing an application server with at least one processor executing machine executable program code for churn prediction refinement, the computer implemented method comprising:
querying a database containing a plurality of customer transactions to retrieve transactions of customers who have churned and transactions of customers who have not churned, each transaction being associated with a set of attributes and a level of support;
(A) performing, by at least one processor, frequent pattern mining on the customer transactions to identify a discriminating pattern which appears frequently in the transactions of customers who have churned but infrequently in the transactions of customers who have not churned, attributes in the discriminating pattern being a root-cause of customer churn;
(B) performing, by at least one processor, churn prediction on the customer transactions to obtain a first list of customers who are likely to churn;
(C) calculating, by at least one processor, a weight for each attribute in the discriminating pattern and multiplying each attribute in the discriminating pattern by its respective weight by the level of support associated with the attributes' respective customer transaction;
(D) performing, by at least one processor, churn prediction on the customer transactions to obtain a second list of customers who are likely to churn;
(E) comparing, by at least one processor, the first list of customers likely to churn to the second list of customers likely to churn;
(F) determining, by at least one processor in response to the comparison, that convergence has occurred when customers on the first and second lists are substantially the same; and
(G) communicating, by at least one processor in response to convergence having occurred, the second list of customers likely to churn to a display device of a customer care agent so that those customers on the second list can be prioritized ahead of customers who are not likely to churn, otherwise repeating (A)-(G).

3. The computer implemented method of claim 2, wherein calculating a weighting value for each attribute in the discriminating pattern comprises:
(a) assigning a weight of 1 to all attributes of all customer transaction not associated with the root-cause of customer churn such that these are all given the same significance;
(b) identifying, from all the attributes weighted 1, an attributed with a maximum support value, the maximum support value being a baseline support; and
(c) calculating, for each attribute in the discriminating pattern, a weighting value comprising: (Support of this attribute−Baseline Support)/Baseline Support.

4. A customer relationship management system comprising:
a database server containing customer transactions of customers who have churned and transactions of customers who have not churned, each customer transaction is associated with a set of attributes and a level of support; and
at least one processor executing machine readable program instructions for:
(A) performing frequent pattern mining on the customer transactions to identify a discriminating pattern which appears frequently in the transactions of customers who have churned but infrequently in the transactions of customers who have not churned, attributes in the discriminating pattern being a root-cause of customer churn;
(B) performing churn prediction on the customer transactions to obtain a first list of customers who are likely to churn;
(C) calculating a weight for each attribute in the discriminating pattern and multiplying each attribute in the discriminating pattern by its respective weight by the level of support associated with the attributes' respective customer transaction;
(D) performing churn prediction on the customer transactions to obtain a second list of customers who are likely to churn;
(E) comparing the first list of customers likely to churn to the second list of customers likely to churn;
(F) determining, in response to the comparison, that convergence has occurred when customers on the first and second lists are substantially the same; and
(G) communicating, in response to convergence having occurred, the second list of customers likely to churn to a display device of a customer care agent so that those customers on the second list can be prioritized ahead of customers who are not likely to churn, otherwise repeating (A)-(G).

5. The customer relationship management system of claim 4, wherein calculating a weighting value for each attribute in the discriminating pattern comprises:
(a) assigning a weight of 1 to all attributes of all customer transaction not associated with the root-cause of customer churn such that these are all given the same significance;
(b) identifying, from all the attributes weighted 1, an attributed with a maximum support value, the maximum support value being a baseline support; and
(c) calculating, for each attribute in the discriminating pattern, a weighting value comprising: (Support of this attribute−Baseline Support)/Baseline Support.
